(19) United States
(12) Patent Application Publication
(10) Pub. No.: US 2026/0093051 A1
(43) Pub. Date: Apr. 2, 2026

(54) SYSTEM FOR INTEGRATING AND AUTOMATING SUBSURFACE INTERPRETATION AND STRUCTURAL MODELING WORKFLOWS

(71) Applicant: Schlumberger Technology Corporation, Sugar Land, TX (US)

(72) Inventors: Aaron ALEE, Lysaker (NO); Matthew Ellwood, Oxford (GB); Shaan Dhumale, London (GB); Amaud Levannier, Prades-le-Lez (FR); Stewart Smith, Stavanger (NO); Surender Manral, Stavanger (NO); Guido van der Hoff, Tananger (NO)

(21) Appl. No.: 19/113,044

(22) PCT Filed: Sep. 18, 2023
(86) PCT No.: PCT/US2023/074460

§ 371 Date: Mar. 19, 2025

Related U.S. Application Data
(60) Provisional application No. 63/376,115, filed on Sep. 19, 2022.

(51) Int. Cl. G01V 1/28; G01V 1/34

(52) U.S. Cl. CPC G01V 1/282; G01V 1/345; G01V 2210/642; G01V 2210/66

(57) ABSTRACT

Methods and systems for subsurface modeling are disclosed. The methods include: generating a set of fault models using fault interpretation data derived from one or more of geological data captured by one or more sensors at a geological site or aggregated historical geological data generated from a plurality of geological sites; executing a filtering operation on the set of fault models to select one or more fault models with a shared property; applying one or more geometry constraints on the one or more fault models to generate a constrained set of fault models; generating a subsurface framework model using the constrained set of fault models, the subsurface framework model indicating consistent horizon data for the geological formation; testing the subsurface framework model based on one or more simulations to generate output data; and initiating generation of one or more visualizations based on the output data for viewing on a graphical display device.

### CROSS-REFERENCE TO RELATED APPLICATIONS

This application claims priority to U.S. Provisional Application No. 63/376,115 filed on Sep. 19, 2022, titled “System For Integrating And Automating Subsurface Interpretation And Structural Modeling Workflows,” which is incorporated herein by reference in its entirety for all purposes.

### BACKGROUND

In the oil and gas industry, the purpose of structural modeling is to build or develop multi-dimensional (e.g., 2-dimensional or 3-dimensional) representations of geological structures or geological formations in a volume of interest of a subsurface (e.g. reservoir zones) associated with a geological site. Relevant considerations required here include determining data associated with one or more contacts between geological layers, referred to as horizons, and confirming discontinuities between displaced geological layers, referred to as faults within the subsurface. Captured seismic data (e.g., data captured by one or more sensors associated with the geological site) may be processed and/or interpreted or otherwise analyzed to extract location data and/or geometry data associated with one or more faults and/or one or more horizons associated with the geological site (e.g., a resource site). The extracted data may be used to generate one or more structural models as shown in FIG. 1A. While a 2-dimensional model is shown in FIG. 1A, exemplary geological models may be characterized by other multi-dimensional models such as 3-dimensional models that define complex geological structures.

Traditionally, seismic interpretation and subsurface modeling operations were done in sequential steps and by geoscientists with different expertise within a team. A plurality of shortcomings associated with previous approaches to seismic interpretation and subsurface modeling operations are discussed in association with FIG. 1B which has plurality of horizon interpretation operations 102, 103, 104, 105, 106, 108, and 110. For example, the horizon interpretation step 104 (e.g., Horizons) shown in FIG. 1B is often prone to data inconsistencies as the created horizon data points comprised in the data generated from executing step 104 do not conform to the resulting horizon model or fault model generated at step 106. This can be due to several factors, such as changes in resolution between data generated from at least two of the processing steps comprised in FIG. 1B as well as limitations in data quality that lead to interpretation features not being reflective of geological relationships embedded in the generated model(s). A clear demonstration of this is the generation of interpretation data points that are on the wrong side of the modeled fault surfaces. This may be due to the impact of remeshing and smoothing operations which result in fault models that deviate from the original input position. Horizon data points can thus spatially occur in incorrect fault locations or fault blocks. This unfortunately results in wrong-sided data points that detrimentally corrupt subsequent subsurface modeling steps as depicted in FIG. 1C (see 120a vs. 120b). More generally, the horizon interpretation processes associated with traditional approaches usually have few embedded geological constraints and often neglect geological rules, for instance, about fault relationships, horizon structural consistency close to faults, and conformance/truncation rules between subsequent horizon interpretations in a stratigraphic sequence.

Additionally, interpretation and modeling workflow operations associated with traditional approaches are often dissociated. For example, a user may generally carry out an interpretation step and then perform validation of the interpretations separately as a precursor to the modeling. This quality check may generally be limited to few geometrical criteria. More advanced techniques allow validation of the geological consistency. Full multi-dimensional (3-dimensional) consistency verification operations on geological models are rather extremely difficult or sometimes impossible using traditional approaches. Even if performed, 3-dimensional inconsistencies in a fault framework associated with truncation rules between non-conformable horizons or in the throw of individual events within a sequence of horizons need to be fully represented and identified which brings with it many challenges in effectively and efficiently adapting seismic interpretations to align said seismic interpretations with geological criteria associated with the structural model.

Furthermore, traditional approaches often employ manual interpretation techniques which are not only time-consuming but are also highly inefficient and prone to human errors. Several commercial applications on the market apply automated techniques or machine-learning based technology to accelerate the process of seismic interpretation. However, these individual technologies are focused on the output of interpretation objects, and not on the consumption of said interpretation objects in downstream workflow tasks. Such applications are therefore not aptly designed to be chained together into efficient automated workflows, nor are these technologies designed to prepare data in a coherent manner for consumption between applications. This creates a challenge to the realized value from the time gains achieved during the interpretation process as additional data post-processing in preparation for structural modeling may be greatly extended.

Moreover, a further limitation of traditional approaches is their lack of incorporating modeling uncertainty data into generated models and/or scenario-based data into the generated models. During the interpretation process, it is necessary to make optimal decisions based on available data and other geological inference data. Such decisions can carry with them significant uncertainties which need to be incorporated into or otherwise accounted for in generated geological models.

### SUMMARY

According to one embodiment, the disclosed technology relates to an integrated and automated subsurface structural interpretation and modelling solution associated with a wider, cloud-based solution herein referred to as “An application system for integrating and automating subsurface geology workflows.” This technology addresses limitations experienced by users (e.g., domain scientists) by coupling automated seismic interpretation methodologies (e.g., using machine learning techniques) with an automated set of subsurface modeling operations. The workflows and associated domain data comprised in this technology may be presented to a user (e.g., a domain scientist) in a geospatial context and/or in a multi-dimensional (e.g., 3-dimensional) visualization (e.g., visual canvas) displayable on a graphical display device.

After a first-order description is derived from captured seismic data (e.g., seismic resolution data), higher resolution information such as wellbore data can be incorporated to refine a geological model generated using the captured seismic data thereby adding additional layers that enrich generated models' definitions based on same. From the resulting multi-dimensional (e.g., 3-dimensional function), a set of meshed surfaces may be generated. Relationship data associated with the meshed horizons and faults to each other in their definitions may lead to a sealed representation (e.g., in the sense that they are closed/non-leaking volumes). The resulting sealed representation may be transformed into a geo-cellular representation through discretization operations. The generated model may comprise regular, hexahedral-like and/or polyhedral elements at specified resolutions. Geo-cellular models may be suitable for consumption in subsequent static and dynamic simulation operations associated with reservoir properties, flow properties, and other geo-mechanical characterizations associated with a geological site. Output data associated with executing the generated models in simulations may be used in control operations associated with development and planning activities at the site (e.g., resource site) such as reserves estimation operations, recovery estimation operations, well placement operations, and or other production optimization operations according to some embodiments of this disclosure.

In other embodiments, this disclosure relates to methods, systems, and computer programs for integrated seismic interpretation and subsurface modeling of a geological formation. The methods, for example, include: generating a set of fault models using fault interpretation data derived from one or more of: geological data captured by one or more sensors at a geological site, or aggregated historical geological data generated from a plurality of geological sites; executing a filtering operation on the set of fault models to select one or more fault models with a shared property; applying one or more geometry constraints on the one or more fault models to generate a constrained set of fault models; generating a subsurface framework model using the constrained set of fault models, the subsurface framework model indicating consistent horizon data for the geological formation; testing the subsurface framework model based on one or more simulations to generate output data; and initiating generation of one or more visualizations based on the output data for viewing on a graphical display device.

In another embodiment, a system and a computer program can include or execute the method described above. These and other implementations may each optionally include one or more of the following features. Applying the one or more geometry constraints on the one or more fault models, according to one embodiment, prevents the one or more fault models from exhibiting wrong-sided data points close to faults. In addition, executing the filtering operation comprises at least one of: a distance-based filtering operation, and an attribute-based filtering operation. Moreover, testing the subsurface framework model based on the one or more simulations can comprises executing an associative operation to establish one or more stratigraphic relationships between horizons associated with the geological formation so that unconformities associated with the selected one or more fault models are correctly interpreted during horizon interpretation operations associated with the simulation. In one embodiment, the horizon interpretation operations comprise applying fault throw constraints to the one or more fault models to predict a horizon geometry close to faults associated with the one or more fault models. In addition, the visualization discussed above can comprises a 2-dimensional or a 3-dimensional visual canvas comprising fault data associated with the geological formation. It is appreciated that the computer processor executing the various processing stages disclosed may be comprised in a cloud-computing platform. Also, a quality control operation may be executed on the one or more fault models prior to generating the subsurface framework model.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1A shows an exemplary visualization generated based on a geological model.

FIG. 1B shows an exemplary workflow associated with a seismic modeling process.

FIG. 1C show two exemplary effects of seismic modeling processes.

FIG. 2 shows a cross-sectional view of a resource site.

FIG. 3 shows a high-level networked system illustrating a communicative coupling of devices or systems associated with the resource site of FIG. 2.

FIGS. 4-5 show exemplary detailed workflows for modeling geological data associated with a geological site.

FIG. 6 shows an exemplary workflow for methods, systems, and computer programs associated with integrated seismic interpretation and subsurface modeling of a geological formation.

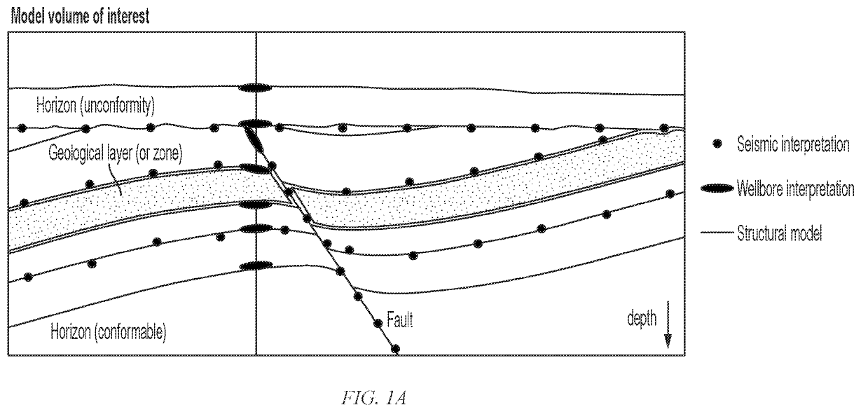

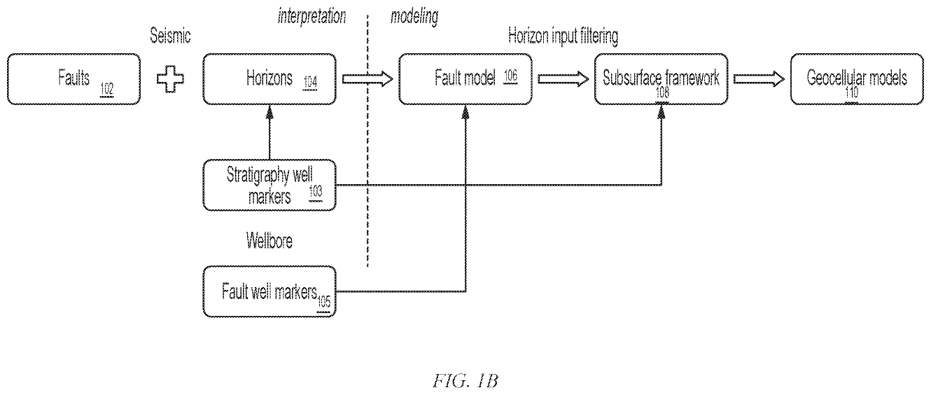

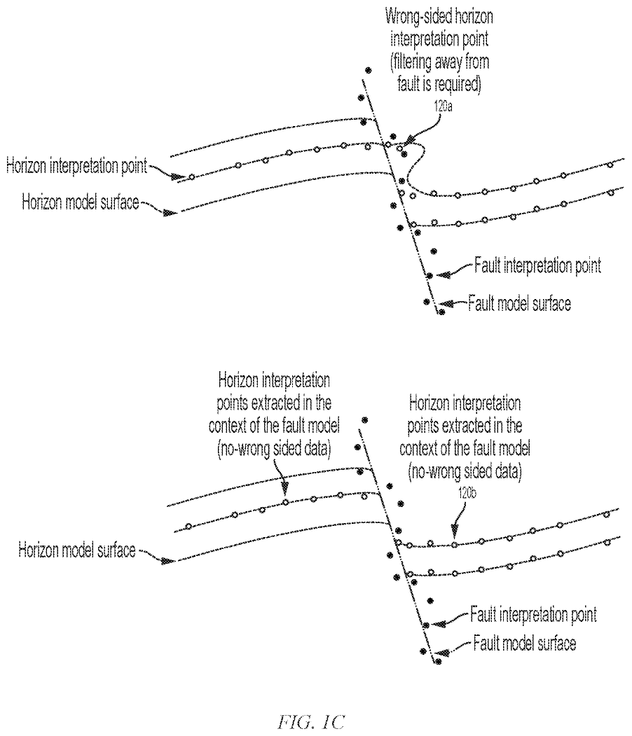

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to the some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring natural resources such as oil, gas, water well industries, and other mineral exploration operations. More specifically, the systems and methods presently disclosed may be applicable to exploring resources such as oil, natural gas, water, and Salar brines. According to some embodiments, the disclosed techniques are applicable to gas storage solutions for storing CO₂, CH₄, or other greenhouse gases in a subsurface region.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, or resource data, etc., is sufficiently accurate.

### Resource Site

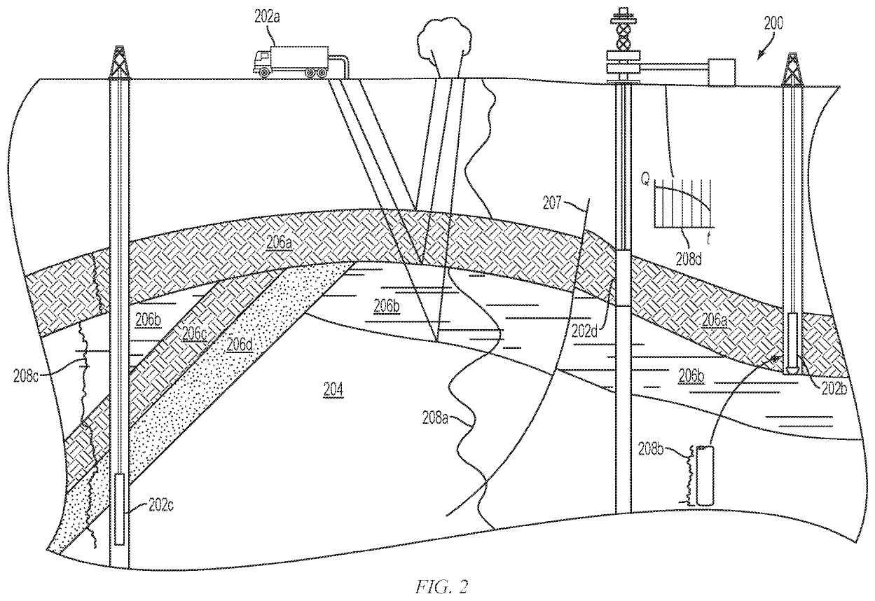

FIG. 2 shows a cross-sectional view of a geological site or resource site 200. While the illustrated resource site 200 represents a subterranean formation, the resource site 200, according to some embodiments, may be below water bodies such as oceans, seas, lakes, ponds, wetlands, rivers, etc. According to one embodiment, various measurement tools capable of sensing one or more parameters such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and collect data for executing the process of disclosed.

Part, or all, of the resource site 200 may be on land, on water, or below water. In addition, while a resource site 200 is depicted, the technology described herein may be used with any combination of one or more resource sites (e.g., multiple oil fields or multiple wellsites, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. The data collected from various sources at the resource site 200 may be processed and/or evaluated and/or used as training data, and or used to generate high resolution result sets for characterizing a resource at the resource site, and/or used for generating resource models, etc.

Data acquisition tool 202a is illustrated as a measurement truck, which may comprise devices or sensors that take measurements of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the oil field 200 to collect data relating to various oil field operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the formation, wellbore, formation fluid/gas, wellbore fluid, gas/oil/water comprised in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or sensors may be used to characterize, or otherwise generate one or more parameter values for a high-resolution result set used to, for example, generate a resource model. In other embodiments, test data or synthetic data may also be used in developing the resource model via one or more simulations such as those discussed in association with the flowcharts presented herein.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of Schlumberger); induction sensors such as Rt Scanner™ (mark of Schlumberger), multifrequency dielectric dispersion sensor such as Dielectric Scanner™ (mark of Schlumberger); acoustic tools including sonic sensors, such as Sonic Scanner™ (mark of Schlumberger) or ultrasonic sensors, such as pulse-echo sensor as in UBI™ or PowerEcho™ (marks of Schlumberger) or flexural sensors PowerFlex™ (mark of Schlumberger); nuclear sensors such as Litho Scanner™ (mark of Schlumberger) or nuclear magnetic resonance sensors; fluid sampling tools including fluid analysis sensors such as InSitu Fluid Analyzer™ (mark of Schlumberger); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

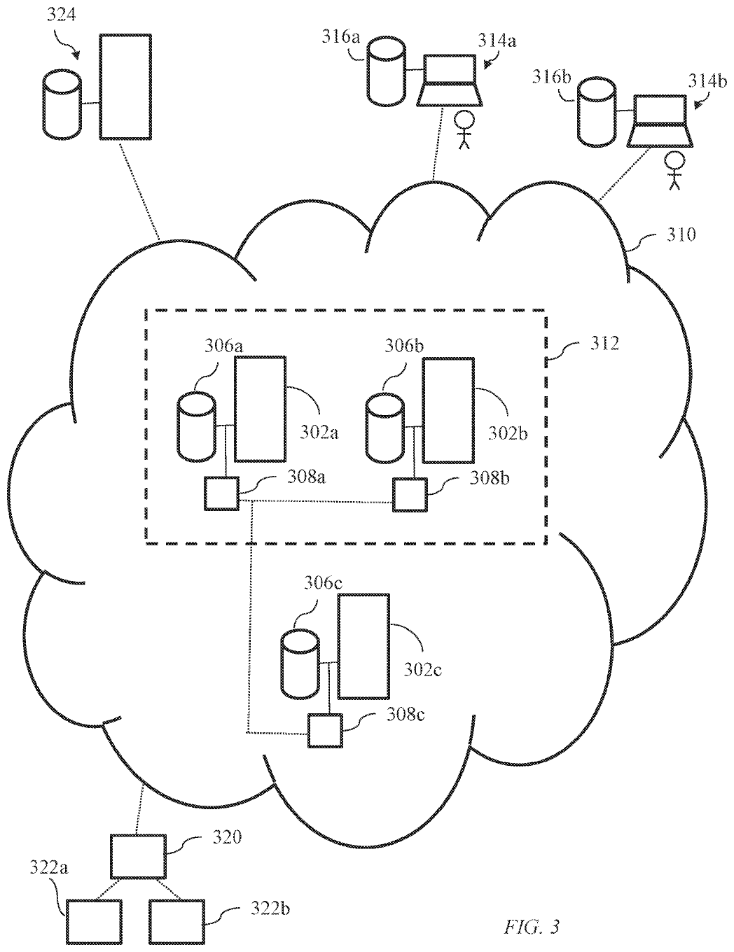

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time or stored for later use. The data may also be combined with historical data or other inputs for further analysis or for modeling purposes to optimize production processes at the oil field 200. In one embodiment, the data is stored in separate databases, or combined into a single database.

### High-Level Networked System

FIG. 3 shows a high-level networked system diagram illustrating a communicative coupling of devices or systems associated with the resource site 200. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the oil field 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more oil fields 200 having, for example, a set of terminals 320, each including at least a processor, a memory, and a communication device for communicating with other devices communicatively coupled to the cloud-computing platform 310. The resource site 200 may also have one or more sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the one or more sensors/sensor interfaces 322a and 322b may be processed to generate a one or more resource models or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more signal processing and/or application specific integrated circuits.

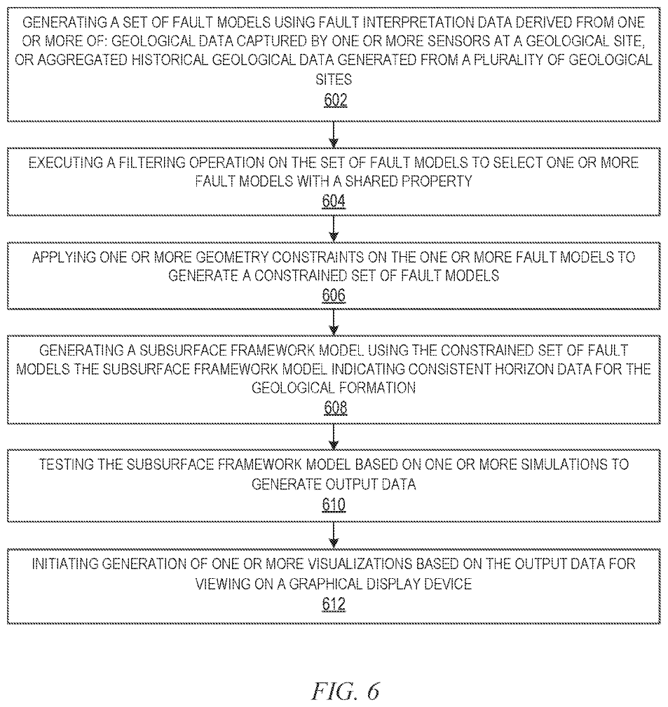

Further, the steps in the flowcharts described below may be implemented by running one or more functional modules in an information processing apparatus such as general-purpose processors or application specific chips, such as ASICs, FPGAs, PLDs, GPUS, or other appropriate devices associated with the system of FIG. 3. For example, the flowchart of FIG. 6 may be executed using a signal processing engine stored in memory 306a, 306b, or 306c such that the signal processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

The disclosed technology provides novel workflows and enabling technologies that facilitate integrated seismic interpretation and subsurface modeling operations. The above-described issues mentioned in association with the background section, for example, are addressed using the disclosed methods and systems. In particular, the proposed solution provides: an enhanced horizon interpretation operation using fault model output and wellbore data; a fast-modeling system with real-time or near real-time mechanisms that facilitate execution of quality control operations on one or more fault model(s) before generation of a subsea framework model and or execution of quality control operations on output data (e.g., interpretation realizations) derived from one or more simulations; and geological uncertainty assessment data generated from executing one or more simulation operations based on one or more structural scenarios associated with a site (e.g., a resource site).

### Enhanced Horizon Interpretation Using Fault Model Output and Wellbore Data

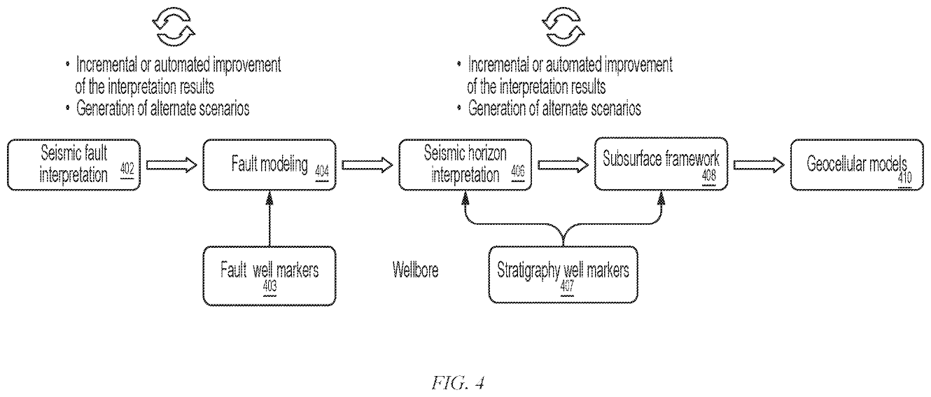

An exemplary workflow associated with the disclosed technology includes automatically generating, using one or more modules of a signal processing engine, one or more fault models based on fault interpretation data as indicated at block 402. The fault interpretation data may be based on real-time or near real-time data captured by one or more sensors associated with a geological site (e.g., a resource site). In some embodiments, the fault interpretation data is based on aggregated historical geological data generated from a plurality of geological sites that have similar and/or dissimilar properties. According to some implementations, the fault interpretation data may include synthetic/training data generated using prior fault models. In some instances, the one or more fault models generated (e.g., at block 404) using the fault interpretation data, synthetic or otherwise, comprise a fault framework (e.g., uniform or consistent fault framework). The one or more fault models may be directly consumed at other stages (e.g., at block 406) of the disclosed workflow of FIG. 4. It is appreciated that the processed or analyzed fault models may be further used at various downstream data processing stages (e.g., at blocks 408 and 410 of FIG. 4). In addition, other augmentation processes such as the inclusion of well marker data from block 403 and the combination of stratigraphy well marker data from block 407 to blocks 406 and 408 of FIG. 4 may also be conducted.

In one embodiment, a data filtering operation may be executed on one or more fault models. At this stage a screening operation may be executed on multiple fault models to select suitable (e.g., fault models having a shared property) or otherwise optimal fault models for construction of a subsurface framework model. The selected fault models may be consumed as input to one or more modules of the signal processing engine for horizon interpretation operations. Applying geometry constraints on the modeled faults (e.g., selected fault models) enables generation of consistent horizons associated with the subsurface framework model. More specifically, said constraining ensures that the modeled faults do not exhibit wrong-sided data points close to faults and are reflective of the fault block within which they are contained by the fault model(s). As a result, the quality of the structural modeling step is greatly improved. In particular, the subsurface framework model may be generated, according to one embodiment, based on the constrained selected fault models. The workflow is also enhanced by the data filtering operation which is based on, for example, a distance-based and/or an attribute-based filtering operation that reconcile inconsistencies associated with the fault model(s). As a result, the proposed methodology and tools allow the subsurface modeling workflow to be done much more efficiently.

The horizon interpretation operations may be augmented to be constrained by geological rules data or other geological knowledge data. This allows enhancing the quality and consistency of the extracted horizon points before consumption by other modules of the signal processing engine for execution of one or more subsurface modeling operations. As an example, associative operations may be executed, during a simulation using the subsurface framework model, to establish one or more stratigraphic relationships between horizons associated with a geological formation so that unconformities associated with selected fault model(s) are more correctly interpreted. In some embodiments, the horizon interpretations operations during the simulation may comprise using or applying fault throw constraints to the one or more selected fault models to better predict the horizon geometry close to faults associated with the selected fault model(s). These constraints can be included directly in the horizon interpretation processes or may be leverage via an iterative process that applies said constraints using a feedback operation associated with the horizon interpretation operations. Additional well marker data associated with the site can also be applied to improve the consistency of the interpretation or to allow for additional horizon levels to be interpreted more accurately.

### Fast-Modeling and Early Quality Control (QC) of Interpretation Realizations

The proposed integrated workflow is also enabled by a new modeling technology (e.g., Hexcell). The computation is significantly faster and more scalable than previous methods by using a dual regular hexahedral grid topological cut-cell grid. The disclosed technology targets performance improvements several orders of magnitude faster. The various operations of the integrated workflow may comprise regularly sampling multi-dimensional (e.g., 2-dimensional) area data and/or sampling multi-dimensional (e.g., 3-dimensional) volume data associated with the resource site for consumption in a cloud-computing platform. In some embodiments, the disclosed technology initiates generation, using the cloud-computing platform, one or more multi-dimensional visualizations for viewing on a graphical display device (e.g., graphical user interface). In one embodiment, the multi-dimensional visualization comprises a 2-dimensional or a 3-dimensional visual canvas comprising fault data associated with a geological formation.

Fast modeling using one or more fault models and/or generated subsurface framework models allows for direct verification of the modeling results over short iterations. The described solution enables early quality control operations of the results from simulations using the one or more fault models and/or simulation outputs associated with the subsurface framework model to iteratively execute horizon interpretation operations by, for example, changing horizon relationship data or interpretation parameters, or altering the subsurface framework model parameters (e.g., the horizon types, model smoothness or data-fit), or perturbing the selected fault model(s), as required to optimize the use of the fault model(s) for generation of the subsurface framework model.

Analysis or inspection operations associated with the foregoing workflow may be used by, or in conjunction with one or more operations by one or more modules of the signal processing engine to evaluate or determine quality control data for the subsurface framework. According to some embodiments, the disclosed technology enables real-time or near real-time generation of one or more visualizations, based on the subsurface framework model after one or more simulations using the subsurface framework model, such that the one or more visualizations indicate cross-sections (e.g., intersection planes) through a volume of interest associated with a geological site, or as a painted attribute on the fault surfaces comprised in geological formations of the geological site. Aspects of the generated visualizations may be co-rendered with input seismic amplitude data and/or other derivative attributes data associated with the geological site. This allows further verification of quality data associated with the subsurface framework relative to other seismic data (e.g., seismic image data) associated with the geological site. Inconsistency data generated in response to the verification data may be used to automatically correct or otherwise optimize the interpretation data and/or optimize parameterization of one or more selected fault models and or parameterization of the subsurface framework model. Beyond generating visualizations, the disclosed technology includes statistical operations executed by one or more modules of the signal processing engine to indicate one or more differences between a model (e.g., one or more fault models) relative to the input seismic data from which the interpretation data is generated. This offers significant efficiency benefits when analyzing complex characterizations associated with the resource site by highlighting problematic areas for optimization and further analysis. To address the source of data inconsistencies associated with the fault model(s) and/or the subsurface framework model(s), a feedback loop between the automated interpretation and stratigraphic operations stage can be established to enhance or otherwise inform the quality of the machine learning processes by providing additional data associated with one or more structures from other interpreted stratigraphic events in the geological volume of interest associated with the geological site. This approach provides a significant opportunity to address challenges with horizon thickness and offset consistency.

While the disclosed solution is primarily data driven (e.g., based on seismic image data and well data captured by one or more sensors at the geological site), it is appreciated that the techniques presented in this disclosure provides a platform that builds or generates models with appropriate levels of characterizations based on one or more objectives of the subsurface modeling study associated with a geological site. For example, to produce a subsurface framework model (e.g., a fit-for-purpose model), a dynamic ranking and fault interpretation parameter criteria can be defined and used to provide quantitative parameterization of one or more fault models to generate the subsurface framework model and thereby optimize the simplification of the geological structure associated with the framework model. This would typically reduce the total number of faults included in the model, which may have several benefits without significantly degrading the model utility. As part of this simplification, the differences between input data and/or output data (e.g., data associated with executing one or more simulation using the subsurface framework model) may be captured. The modeling choices can also be documented using an annotation and validation process on one or more generated models.

According to some implementations, the disclosed method includes executing a structural analysis operation and/or a fault analysis operation on one or more models (e.g., selected fault model and or generated subsurface framework model) based on one or more fault attribute data including fault throw profile data associated with the resource site and/or throw consistency data associated with the resource site, etc. This improves, according to some embodiments, the quality of the output data including computed fault offset data. By executing analysis operations to generate fault offset data, a more complete assessment of the structural consistency associated with one or more geological formations at the resource site may be made for execution of one or more control operations using one or more equipment at the geological site.

### Geological Uncertainty Assessment Through Multiple Structural Scenarios

According to some implementations of this disclosure, uncertainty data associated with one or more portions of the resource site being modeled may be incorporated into parameterizing one or more fault models and/or one or more subsurface framework models. The uncertainty data may include: uncertainty data associated with measurement data at the geological site and uncertainty data associated with one or more parameters used to parameterize the fault model(s) and/or the subsurface framework model as well as uncertainty data associated with representing one or more geological formations associated with the geological site. According to one embodiment, one or more structural scenarios may be used to generate or otherwise quantify the uncertainty data. Said structural scenarios may also inform parameter selection for parameterizing the selected fault model(s) and/or subsurface framework model(s).

According to some embodiments, data (e.g., modeling choices) associated with output data generated by executing one or more modeling or simulation operations using the fault model(s) and or the subsurface framework model(s) may be stored in the form of interpretation data and model parameter set data such that relationship data between the modeled objects (e.g., multiple interpretation scenarios, fault relationships, horizon types, etc.) may also be stored in conjunction with the stored data. Given that scenarios may be related in some instances, a replication operation may be used to automatically replicate initial model parameters from one model (e.g., fault model(s) or subsurface framework model(s)) for use by subsequent alternative scenarios and thereby accelerate the creation of the subsequent models. The seamless creation of scenarios data supports users (e.g., domain scientists) in executing testing (e.g., simulation) operations based on variation data that impact the full static and dynamic characterizations associated with the modeling process. One or more scenarios can be tested based on different topological complexity data (e.g., alternative fault connections driven by changes in extraction parameters that impact the size and continuity of extracted faults) where one or more modeling parameter changes affect relevant model characteristics (e.g., different numbers of fault compartments based on alternative parameterization of fault extension) and fault connectivity properties based on layer offset (e.g., changes to cross-fault juxtapositions driven by increases or decreases in fault offset). The efficient creation of these scenarios may be enabled by executing one or more operations discussed above in a parallel computing architecture (e.g., a cloud-computing platform with parallel computing capabilities) to expedite the generation of the output data associated with testing the selected fault model(s) and/or the generated subsurface framework model.

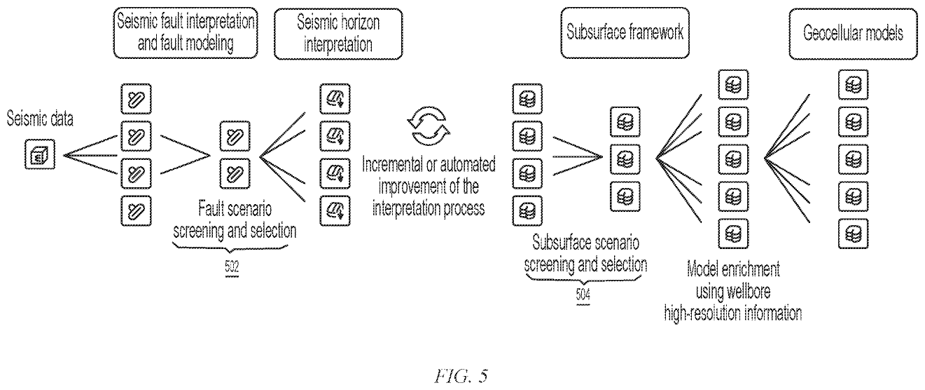

Scenario management may be supported by one or more user interface frameworks associated with the above signal processing engine. The one or more user interface frameworks may optimize the output data (e.g., output data generated based on tests executed on the fault mode(s) and/or on the subsurface framework model(s) and/or associated visualizations) for viewing and interaction on graphical user interfaces. For example, the optimizations may be based on a device type and/or display screen type of the graphical user interface. According to some implementations, one or more visualization techniques may be used to visualize the output data based on representation criteria associated with one or more scenarios as shown in FIG. 5. For example, cluster visualization of the model properties per fault block, graph representation of the model topology, etc. may be exemplary visualization techniques adopted by some embodiments of this disclosure. These techniques may be used to emphasize or otherwise highlight specific aspects of the output data (e.g., data selections of scenarios 502 and 504 with specific characteristics associated with the output data) for display on the graphical user interface. In addition, one or more quantitative analysis operations may be incorporated into the model generation operation outlined above. For example, the distance comparison operations structural models (e.g., scenario entropy) associated with the subsurface framework model, oil in place determination operations, geological screening techniques linked to criteria of connectivity, or dynamic response operations assessed through the reservoir simulation are exemplary quantitative analysis operations that may be incorporated into the tests executed using the foregoing techniques.

According to some embodiments, data lineage may be preserved through the entire workflow, so that a user can relate a specific component of a scenario to the input used in generation of output data as well as other relationships to children objects downstream. For instance, a structural model scenario (e.g., a scenario used to generate one or more of a fault model and/or a subsurface framework model) may be used to link a parent interpretation data and/or a fault model upstream to one or more children grids and/or simulation cases downstream. This is particularly important in facilitating agile recalculations and/or generation of selected fault model(s) and/or subsurface framework model(s) based on additional input data or new insights. As the calculations are linked to data and automated processes through the end-to-end workflow, a new update can be easily triggered automatically, and the resulting model(s) with attendant output data generated.

Exemplary unmet needs addressed by the disclosed technology include:
a. inefficiencies associated with subsurface interpretation and modeling workflows that present very limited quality control opportunities before completion of the full workflow;
b. inefficiencies associated with considering fault model geometries when interpreting data associated with horizons of a geological formation;
c. inability to add geological constraints (e.g., parameters) in automated horizon interpretation operations (e.g., simulation operations); and
d. inability to automate fault interpretation and modelling operations in a combined workflow makes testing of uncertainty very challenging and discourages users (e.g., domain geoscientists) from promoting more than one version of a fault framework.

The disclosed technology integrates data interpretation operations with model generation operations to allow users dynamically visualize output data from geological tests (e.g., simulations using one or more models) and conduct quality control operations during and/or after execution of said tests. Moreover, the disclosed technology enables reuse of optimal models and/or optimal model workflows based on the one or more geological tests. Furthermore, the disclosed technology enables augmenting the geological model process with automatic operations that are executed based on a plurality of scenarios and or based on a plurality of uncertainty data leading to generation of very optimal and practical subsurface model frameworks for use in control operations (e.g., development operations such as drilling, fracking, well placement operations, etc.). In some embodiments, the term optimal and its variants (e.g., efficient, optimally, etc.) may simply indicate improving, rather than the ultimate form of ‘perfection’ or the like. Furthermore, the disclosed methods and systems provide an enhanced horizon interpretation using fault model(s) as well as wellbore data for consumption in a structural modeling architecture. In one embodiment, the disclosed processes enable improved modeling runtime performance through processes that are executed in real-time or near real-time, enhanced optimization of data storage due to the data structures engaged in processing and storing model data, and utilization of cloud computing systems that do not require user devices to computationally execute the one or more workflows disclosed. The disclosed approach leverages geological uncertainty data in the assessment operations through the generation and management of structural scenarios.

### Flow Chart

FIG. 6 provides an exemplary workflow for methods, systems, and computer programs associated with integrated seismic interpretation and subsurface modeling of a geological formation. It is appreciated that a data manager or a data processing engine or a signal processing engine stored in a memory device may cause a computer processor to execute the various processing stages of FIG. 6.

At block 602, the signal processing engine may generate a set of fault models using fault interpretation data derived from one or more of: geological data captured by one or more sensors at a geological site, or aggregated historical geological data generated from a plurality of geological sites. It is appreciated that a fault model may comprise one or more fault objects together with corresponding model descriptors that indicate discontinuity data associated with the subsurface being modeled. The one or more fault objects may be adapted to represent a 3-dimensional surface which delimits geological discontinuities comprised in the subsurface being modeled, according to some embodiments. The geological discontinuities may comprise, for example, stratigraphic discontinuities and/or fluid flow discontinuities.

Turning to block 604, the signal processing engine may execute a filtering operation on the set of fault models to select one or more fault models with a shared property. These properties may include: complexity data associated with reservoir compartments within the subsurface which impact fluid flow or in-place fluid conditions; hydrodynamic connectivity data between said compartments which can impact fluid production; and fault area data comprised in the subsurface. In one embodiment, the signal processing engine may apply, at block 606, one or more geometry constraints on the one or more fault models to generate a constrained set of fault models. The constraints, for example, may comprise: a smoothness constraint associated with the fault model; and a horizon displacement constraint associated with the fault model.

In addition, the signal processing engine may generate, at block 608, a subsurface framework model using the constrained set of fault models. The subsurface framework model may indicate consistent horizon data for the geological formation. According to one embodiment, the consistent horizon data may indicate geological consistency information that reflect relatively smooth horizons comprised in the subsurface relative to one or more faults within the subsurface in, for example, sections within the subsurface where the depth of the horizon surface is discontinuous. In addition, similar trend data associated with adjacent horizons of the same conformable stratigraphic sequence may be indicated in the consistent horizon data. In some instances, the similar trend data may include data representing horizon surface interactions within the subsurface. It is appreciated that the consistent horizon data may be constrained by the geometry of the modeled faults to enhance the consistency of the consistent horizon data. More specifically, the generated consistent horizon data, according to one embodiment, does not exhibit wrong-sided data points much less wrong-sided data points close to faults. In addition, the consistent horizon data reflects one or more faults associated with the set of fault models. At block 610, the signal processing engine may test the subsurface framework model based on one or more simulations, to generate output data. According to one embodiment, the output data may be used to generate or format structural geological models associated with the subsurface during the testing process by varying model parameters such as one or more spatial resolution parameters and/or one or more smoothness parameters associated with horizon surfaces comprised in the subsurface framework model. According to one embodiment, one or more parameters of the subsurface framework model including parameters affecting resulting fault throws may also be varied to generate the output data as part of the testing. One of the testing objectives involves generating model scenarios of the structure of the subsurface framework model with assessments on the implications associated with location and volume data of a targeted resource (e.g., oil, gas, water, etc.) associated with the subsurface framework model. According to one embodiment, the tests involve simulating a plurality of different scenarios indicating a static or a dynamic compartmentalization within the subsurface which impacts the ability to produce and/or extract the resource in question. The signal processing engine may, at block 612, initiate generation of one or more visualizations based on the output data for viewing on a graphical display device. According to one embodiment, the output data and/or visualizations generated from the output data may facilitate or optimize energy development operations with varying degrees of uncertainty such as well placement operations, resource (e.g., crude, gas, water, etc.) extraction or production plans (e.g., reports, files, etc.) for said resource extraction, gas storage operations associated with the subsurface, flow control device (e.g., valve aperture) configurations, etc.

In another embodiment, a system and a computer program can include or execute the method described above. These and other implementations may each optionally include one or more of the following features. Applying the one or more geometry constraints on the one or more fault models, according to one embodiment, prevents the one or more fault models from exhibiting wrong-sided data points close to faults. In particular, the occurrence of wrong-sided horizon data can be canceled, reduced, or mitigated by constraining the geometry of the generated one or more fault models during the disclosed horizon interpretation process. In addition, executing the filtering operation comprises executing at least one of: a distance-based filtering operation, and an attribute-based filtering operation. The attributes considered during the attribute-based filtering may leverage geometrical attribute data associated with the set of fault models to filter the set of fault models. Other attributes considered in the filtering process can include confidence data associated with generating the set of fault models or other topological relationship data associated with the set of fault models including relationship data between faults, relationship data between horizons, or relationship data between faults and horizons.

Moreover, testing the subsurface framework model based on the one or more simulations can comprise executing an associative operation to establish one or more stratigraphic relationships between horizons associated with the geological formation so that unconformities/discontinuities associated with the selected one or more fault models are correctly interpreted during horizon interpretation operations associated with the testing/simulation. In one embodiment, the horizon interpretation operations comprise applying fault throw constraints to the one or more fault models to predict a horizon geometry close to faults associated with the one or more fault models. According to one embodiment, the faults represent horizon displacement surfaces within the subsurface being modeled. The fault throw constraint may be related to said geological displacement surfaces. In particular, the fault throw constraint may represent a vertical horizon offset between a footwall side and a hanging wall side of a fault comprised in the faults based on, for example, a fault slip direction over the fault surface of the fault comprised in the faults. When creating a structural model, specific constrains can be prescribed on the model fault surfaces to generate geologically consistent horizons. In addition, the visualization discussed above can comprise a 2-dimensional or a 3-dimensional visual canvas comprising fault data associated with the geological formation. It is appreciated that the computer processor executing the various processing stages disclosed may be comprised in a cloud-computing platform. Also, a quality control operation may be executed on the one or more fault models prior to generating the subsurface framework model.

It is further appreciated that assessing the quality of the fault framework during the quality control (QC) operation includes several processing stages. These processing stages include: assessing, using a signal processing engine, for example, the quality of a model fault surface associated with the output data relative to input data (e.g., data used to generate the set of fault models), evaluating a geological consistency of the resulting fault model associated with the output data to, for example, remove the impact or effects of incorrect interpretation points that relate to measurement noise comprised in the captured geological data (see block 602 of FIG. 6); and factoring data outlier mitigation operations into of downstream workflow steps (e.g., steps 608-612 of FIG. 6) to avoid data or computational anomalies in the downstream workflow steps. According to one embodiment, the foregoing QC operations may be executed before or after the generation of the subsurface framework model. According to one embodiment, the subsurface framework model represents a multi-dimensional (e.g., 3-dimensional) volumetric representation of the subsurface, including one or more faults together with geological layers separated by one or more horizons surfaces associated with the subsurface.

While any discussion of or citation to related art in this disclosure may or may not include some prior art references, Applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to use the invention and various embodiments with various modifications as are suited to the particular use contemplated.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining”or “in response to detecting,”depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for integrated seismic interpretation and subsurface modeling of a geological formation, the method comprising:
generating, using a computer processor, a set of fault models using fault interpretation data derived from one or more of:
geological data captured by one or more sensors at a geological site, or
aggregated historical geological data generated from a plurality of geological sites;
executing, using the computer processor, a filtering operation on the set of fault models to select one or more fault models with a shared property;
applying, using the computer processor, one or more geometry constraints on the one or more fault models to generate a constrained set of fault models;
generating, using the computer processor, a subsurface framework model using the constrained set of fault models, the subsurface framework model indicating consistent horizon data for the geological formation;
testing, using the computer processor, the subsurface framework model based on one or more simulations, to generate output data; and
initiating, using the computer processor, generation of one or more visualizations based on the output data for viewing on a graphical display device.

2. The method of claim 1, wherein applying the one or more geometry constraints on the one or more fault models prevents the one or more fault models from exhibiting wrong-sided data points close to faults.

3. The method of claim 1, wherein the filtering operation includes at least one of:
a distance-based filtering operation, and
an attribute-based filtering operation.

4. The method of claim 1, wherein testing the subsurface framework model based on the one or more simulations includes executing an associative operation to establish one or more stratigraphic relationships between horizons associated with the geological formation so that unconformities associated with the selected one or more fault models are correctly interpreted during horizon interpretation operations associated with the simulation.

5. The method of claim 4, wherein the horizon interpretation operations include applying fault throw constraints to the one or more fault models to predict a horizon geometry close to faults associated with the one or more fault models.

6. The method of claim 1, wherein the visualization includes a 3-dimensional visual canvas including fault data associated with the geological formation.

7. The method of claim 1, wherein the computer processor is included in a cloud-computing platform.

8. The method of claim 1, wherein a quality control operation is executed on the one or more fault models prior to generating the subsurface framework model.

9. A system for integrated seismic interpretation and subsurface modeling of a geological formation, the system comprising:
a computer processor, and
memory storing instructions that are executable by the computer processor to:
generate a set of fault models using fault interpretation data derived from one or more of:
geological data captured by one or more sensors at a geological site, or
aggregated historical geological data generated from a plurality of geological sites;
execute a filtering operation on the set of fault models to select one or more fault models with a shared property;
apply one or more geometry constraints on the one or more fault models to generate a constrained set of fault models;
generate a subsurface framework model using the constrained set of fault models, the subsurface framework model indicating consistent horizon data for the geological formation;
test the subsurface framework model based on one or more simulations to generate output data; and
initiate generation of one or more visualizations based on the output data for viewing on a graphical display device.

10. The system of claim 9, wherein applying the one or more geometry constraints on the one or more fault models prevents the one or more fault models from exhibiting wrong-sided data points close to faults.

11. The system of claim 9, wherein the filtering operation includes at least one of:
a distance-based filtering operation, and
an attribute-based filtering operation.

12. The system of claim 9, wherein the visualization includes a 3-dimensional visual canvas including fault data associated with the geological formation.

13. The system of claim 9, wherein the computer processor is included in a cloud-computing platform.

14. The system of claim 9, wherein a quality control operation is executed on the one or more fault models prior to generating the subsurface framework model.

15. A computer program comprising instructions, that when executed by a computer processor of a computing device, causes the computing device to:
generate a set of fault models using fault interpretation data derived from one or more of:
geological data captured by one or more sensors at a geological site, or
aggregated historical geological data generated from a plurality of geological sites;
execute a filtering operation on the set of fault models to select one or more fault models with a shared property;
apply one or more geometry constraints on the one or more fault models to generate a constrained set of fault models;
generate a subsurface framework model using the constrained set of fault models, the subsurface framework model indicating consistent horizon data for a geological formation;
test the subsurface framework model based on one or more simulations to generate output data; and
initiate generation of one or more visualizations based on the output data for viewing on a graphical display device.

16. The computer program of claim 15, wherein applying the one or more geometry constraints on the one or more fault models prevents the one or more fault models from exhibiting wrong-sided data points close to faults.

17. The computer program of claim 15, wherein the filtering operation includes at least one of:
a distance-based filtering operation, and
an attribute-based filtering operation.

18. The computer program of claim 15, wherein the visualization includes a 3-dimensional visual canvas including fault data associated with the geological formation.

19. The computer program of claim 15, wherein the computer processor is included in a cloud-computing platform.

20. The computer program of claim 15, wherein a quality control operation is executed on the one or more fault models prior to generating the subsurface framework model.
